(19) United States
(12) Patent Application Publication
(10) Pub. No.: US 2010/0260977 A1
(43) Pub. Date: Oct. 14, 2010

(54) CHEMICAL MECHANICAL FABRICATION (CMF) FOR FORMING TILTED SURFACE FEATURES

(75) Inventors: Rajiv K. Singh, Gainesville, FL (US); Purushottam Kumar, Gainesville, FL (US); Deepika Singh, Gainesville, FL (US); Arul Chakkaravarthi Arjunan, Gainesville, FL (US)

Correspondence Address: Jetter & Associates, P.A., 8295 North Military Trail, Suite F, Palm Beach Gardens, FL, 33410, US

(73) Assignees: SINMAT, INC., Gainesville, FL (US); UNIVERSITY OF FLORIDA RESEARCH FOUNDATION, INC., Gainesville, FL (US)

(21) Appl. No.: 12/759,307

(22) Filed: Apr. 13, 2010

Related U.S. Application Data
(60) Provisional application No. 61/168,858, filed on Apr. 13, 2009.

(51) Int. Cl. B32B 3/00; B32B 43/00

(52) U.S. Cl. 428/172; 216/53

(57) ABSTRACT

A method of chemical-mechanical fabrication (CMF) for forming articles having tilted surface features. A substrate is provided having a patterned surface including two different layer compositions or a non-planar surface having at least one protruding or recessed feature, or both. The patterned surface are contacted with a polishing pad having a slurry composition, wherein a portion of surface being polished polishes at a faster polishing rate as compared to another portion to form at least one tilted surface feature. The tilted surface feature has at least one surface portion having a surface tilt angle from 3 to 85 degrees and a surface roughness<3 nm rms. The tilted surface feature includes a post-CMF high elevation portion and a post-CMF low elevation portion that defines a maximum height (h), wherein the tilted surface feature defines a minimum lateral dimension (r), and h/r is ≧0.05.

### CROSS REFERENCE TO RELATED APPLICATIONS

This application claims the benefit of Provisional Application Ser. No. 61/168,858 entitled “CHEMICAL MECHANICAL FABRICATION(CMF) FOR FORMING NON-PLANAR OR TILTED SURFACE FEATURES”, filed Apr. 13, 2009, which is herein incorporated by reference in its entirety.

### FIELD OF THE INVENTION

Disclosed embodiments relate to a variant of a chemical mechanical polishing (CMP) process and articles having tilted surface features therefrom.

### BACKGROUND

In the last couple of decades CMP has grown from a glass polishing technology to a standard integrated circuit (IC) fabrication technique. CMP ensures the miniaturization of ICs by providing an appropriate copper removal technique for forming metal interconnects and also providing flatter wafer surfaces needed for next generation lithographic tools. CMP is used in both front-end and back-end processing, such as in trench isolation, inter-level dielectric (ILD) planarization, local tungsten interconnects, and copper damascene.

CMP is also finding applications in wafer planarization of non-silicon semiconductor materials, such as wide band gap semiconductors including SiC and GaN for providing substantially damage free substrates. Research and development in CMP has focused on achieving better local and global wafer planarity, lower defectivity and substantially damage-free surfaces, which are fundamental needs of the semiconductor industry. Accordingly, CMP has become synonymous with chemical-mechanical planarization. Non-planarizing phenomenon, such as dishing and edge rounding (also known as erosion), are categorized as undesirable defects in CMP processing and significant efforts have been made, and continue to be made, to reduce or eliminate such defects.

For example, since dishing is known to mostly be a result of mechanical forces, reduced mechanical forces (e.g. pad pressure) have been used to reduce dishing. Abrasive particles have also been eliminated in some slurries to reduce dishing, commonly referred to as abrasive-free polishing (AFP). A worst case aspect ratio of the feature created under sever dishing conditions during CMP is generally no more than 0.005.

### SUMMARY

Embodiments of the invention are drawn to methods of chemical-mechanical fabrication (CMF) for forming articles having at least one and generally a plurality of tilted surface features and articles having tilted surface features therefrom. CMF is a chemical mechanical polishing process that is a variant of CMP. In CMP, the surfaces formed are generally substantially planar throughout and are thus essentially featureless surfaces. In contrast, CMF forms articles having tilted surface features.

Embodiments of the invention generally comprise providing a substrate having a patterned surface. The “patterned” surface for CMF processing can be a planar surface, where the “pattern” refers only to different compositions (that have different polishing rates) on different areas of the surface, referred to herein as compositionally patterned. The two or more layers of different compositions provide a polishing selectivity of >1.5, and can provide a polishing selectivity of >20, such as >20 to 100.

The patterned surface can also be a non-planar surface that comprises at least one pre-CMF protruding or recessed feature. In the protruding or recessed feature embodiment, the protruding or recessed feature comprises a first composition, and has a pre-CMF high elevation portion and a pre-CMF low elevation portion. A vertical distance (height) between the pre-CMF high portion and pre-CMF low portion is ≧10 nm. The pre-CMF high portion includes a center portion and an edge portion. In this embodiment The pre-CMF high portion is contacted with a polishing pad having a slurry composition therebetween. The slurry composition is moved to polish the center and edge portion, wherein the edge portion polishes at a faster polishing rate as compared to a polishing rate of the center portion to form at least one tilted surface feature. The tilted surface feature formed comprises at least one surface portion having a surface tilt angle from 3 to 85 degrees and a surface roughness<10 nm rms.

In the compositionally patterned embodiment, the patterned surface comprises of more than one different composition. The polishing rate of one composition is different from the polishing rate of the other composition providing a selective polishing process. The composition with a lower polishing rate provides a polishing stop layer. The surface can be patterned with a mask. The polishing rate in the masked region may have a different polishing rate as compared to the non-masked region resulting in creation of tilted or CMF surface. In this case, planar surface can be transformed to a non-planar tilted surface.

Surface roughness measures the random height differences from the mean height on either planar or non-planar surfaces. The mean height of roughness as used herein is calculated as an root mean square (rms) value based on average of the random surface roughness profiles for at least 3 and not more than 100 wavelengths of roughness which are in the range of 1-50 nm. The wavelength of roughness and the mean height of roughness can be measured by any standard atomic force microscope such as by the Veeco DIMENSION 5000 (Veeco Instruments Inc. Plainview, N.Y.). The mean surface roughness of the features created by disclosed embodiments are typically less than 10 nm rms roughness, such as less than 2 nm rms roughness, or less than 1 nm rms roughness.

### BRIEF DESCRIPTION OF THE DRAWINGS

FIG. 1A shows a plot of the high to low (or peak to valley) height (Rₚᵥ) of feature(s) formed as a function of polishing time that defines the CMF polishing time zones relative to CMP, according to an embodiment of the invention.

FIG. 1B shows a plot of Rₚᵥ as a function of polishing time that defines the CMF time zones relative to CMP, for the embodiment where the minimum Rₚᵥ value does not reach below 10 nm.

FIGS. 2A-P show examples of tilted surface features that can be fabricated by CMF methods according to embodiments of the invention including symmetric surfaces (A-E), asymmetric surfaces (F-J), negative curvature surfaces (K), FIG. 2K being further identified as an article comprising a plurality of recessed and tilted surface features, positive curvature surfaces (L) with FIG. 2L being further identified as an article comprising a plurality of protruding and tilted surface features, mixed curvature surfaces (M), and mixed structures (N-P), respectively.

FIGS. 3A-C show some exemplary feature shapes obtainable using the under-polish regime of CMF, according to an embodiment of the invention. The solid lines show the structure as provided, while the dashed lines show the resulting structure as the time for CMF increases.

FIG. 4 shows an initial feature profile and a feature profile after CMF (dashed lines) in the embodiment where a polishing stop layer is positioned proximate to the center portion of the high elevation portion of the features, according to an embodiment of the invention.

FIG. 5 shows a plot of the peak to valley height (Rₚᵥ) as a function of processing time that defines the CMF zones relative to CMP for the polishing stop layer comprising embodiment, according to an embodiment of the invention.

FIGS. 6A and B show an initial feature profile (solid lines) and a feature profile after CMF for various times (dashed lines) in the embodiment where polishing stop layer is positioned proximate to an edge portion of the top of the features, according to an embodiment of the invention As shown, this embodiment creates asymmetric features.

FIGS. 7A and B show a depiction of respective materials that have surfaces including different widths and different polishing rates (polishing selectivity of one material over other), and feature profiles before (solid lines) and after CMF (dashed lines) obtained by polishing such surfaces, according to an embodiment of the invention. The depth shown as ‘H’ refers to the height of the CMF structure.

FIGS. 8A and B shows a feature profile before (solid lines) and after CMF (dashed lines) in an embodiment where the starting structure is a substantially planar surface (Rmax<1 nm) comprising two materials with different removal rates during polishing (thus providing selectivity), while FIG. 8C shows a plot of R_{PV} vs. time showing times for the CMF regime, according to an embodiment of the invention.

FIGS. 9A and B show depictions of a structure before and after CMF, respectively, according to an embodiment of the invention.

FIG. 10A shows a depiction of a post CMF processed structure that evidences the formation of both positive and negative curvature surfaces while FIG. 10B provides a plot that quantifies the height of the positive and negative curvature surfaces along a lateral dimension, according to an embodiment of the invention.

FIG. 11A shows a depiction of a substrate having surface features formed by wet etching along with a plot that quantifies the height along the surface, while FIG. 11B shows the resulting structure after CMF along with a plot that quantifies the height along the surface, according to an embodiment of the invention.

FIG. 12A shows a depiction of a negative curvature microlens structure, while FIG. 12B a plot that quantifies the height along the surface of the negative curvature microlens structure shown in FIG. 12A, according to an embodiment of the invention.

### DETAILED DESCRIPTION

Embodiments of the invention are described with reference to the attached figures, wherein like reference numerals are used throughout the figures to designate similar or equivalent elements. The figures are not drawn to scale and they are provided merely to illustrate disclosed features. Several disclosed aspects are described below with reference to example applications for illustration. It should be understood that numerous specific details, relationships, and methods are set forth to provide a full understanding of this Disclosure. One having ordinary skill in the relevant art, however, will readily recognize that embodiments of the invention can be practiced without one or more of the specific details or with other methods. In other instances, well-known structures or operations are not shown in detail to avoid obscuring inventive features. Embodiments of the invention are not limited by the illustrated ordering of acts or events, as some acts may occur in different orders and/or concurrently with other acts or events. Furthermore, not all illustrated acts or events are required to implement a methodology in accordance with the embodiments of the invention.

As described above, CMF is a variant of CMP. In conventional CMP, the surfaces formed are generally substantially planar throughout and are thus essentially featureless surfaces. As defined herein, a substantially planar surface (such as provided by a conventional CMP process) is characterized by absence of surface features, or surface features that have a maximum tilt angle of 2 degrees, and a h/r ratio of the features that is <0.005, wherein “h” refers to the height/vertical distance of the features, and “r” refers to the minimum lateral distance(s) for the features in arrangements where h is changing (i.e. non-planar). In contrast, patterned surfaces provided by CMF methods according to embodiments of the invention comprise at least one tilted surface feature having at least one surface portion that provides a tilt angle in the range from 3 to 85 degrees, with a typical range from 10 to 80 degrees, and an h/r ratio of the features that is >0.05.

Feature shapes provided by CMF acting on patterned surfaces can be symmetric or non-symmetric (asymmetric/complex) shapes. When a disclosed feature is symmetric, the feature has a single minimum lateral dimension “r”. When a disclosed feature is asymmetric and has multiple “r” dimensions, as used herein the minimum lateral dimension “r” is the smallest of r₁, r₂, . . . values.

If the features are symmetric, such as a pyramid which is a triangle in 2 dimensions, then h varies over a total lateral distance of “2r”. If the symmetric feature includes a planar top, the lateral distance traversed by the planar top does not contribute to the r value since h is constant at the top of the features. If the feature shape is an asymmetric/complex shape, then total dimension for the features is the sum of two or more different r values, such as r₁+r₂, r₁+r₂+r₃. It is noted that “h” can also be different values (though only h₁ having one value is shown). For different values of “h” in a structure, as used herein, the largest value of “h” is used.

As described above, the h/r ratio of the features for disclosed embodiments is generally ≧0.05. The tilted surface features provided by CMF processing according to embodiments of the invention thus opens new applications including a surface shaping process, and devices and articles therefrom.

The patterned substrates and surfaces can comprise a wide variety of materials. Exemplary materials for the patterned surface can comprise glass, SiC, GaN, carbides, nitrides, sapphire, an oxide, an optically transparent electrically conducting oxide, or a phosphor.

Features formed by CMF as described herein, as with CMP, do not change the surface composition on the outer surface of the features formed. Thus, the composition of the outer surface and the sub-surface defined herein to begin 1 nm below the outer surface of the feature both have same composition. In contrast, features formed by reactive ion etching (RIE) are known to have an outer surface that due to chemical reaction during the RIE process form features having an outer surface composition that is different from the subsurface composition.

Features formed by CMF also do not create microstructural damage such as scratches, dislocations, amorphization of the surface, surface pits, chemical etch defect delineation. Thus the microstructural quality of the surface is same or better as the sub-surface region. Techniques such as RIE can cause pits and defects e.g. amorphization in the surface thus altering the surface and subsurface microstructure from the bulk. The CMF formed surface may exhibit atomically terraced surface in single crystal material such as but not limited to GaN, Sapphire, AlN. Such features are not observed by RIE method.

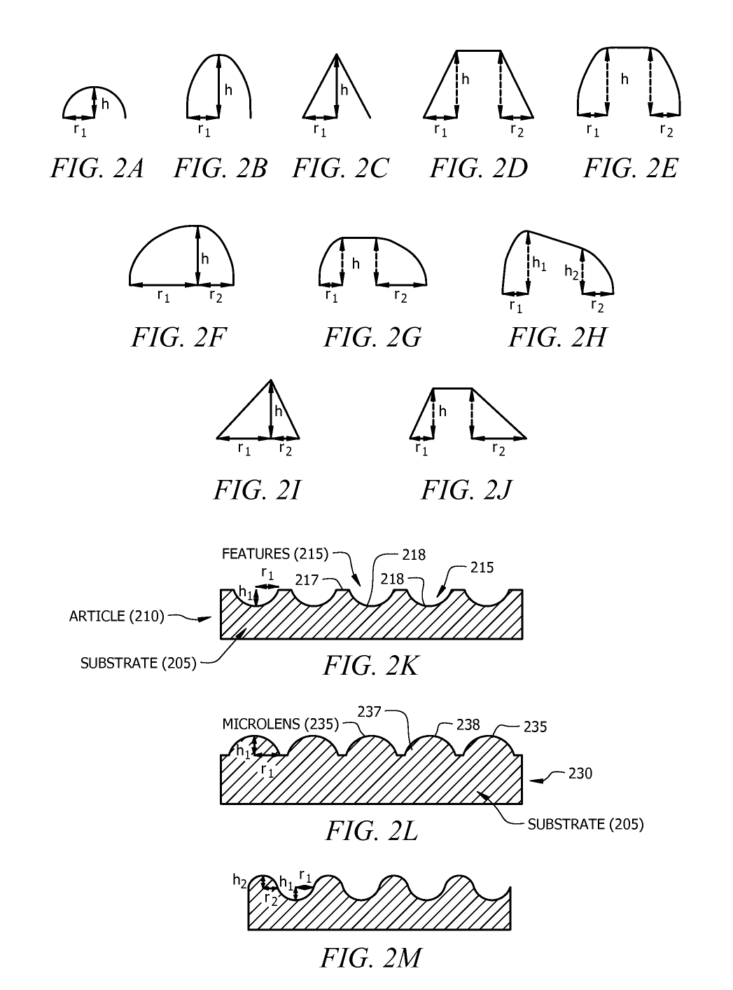

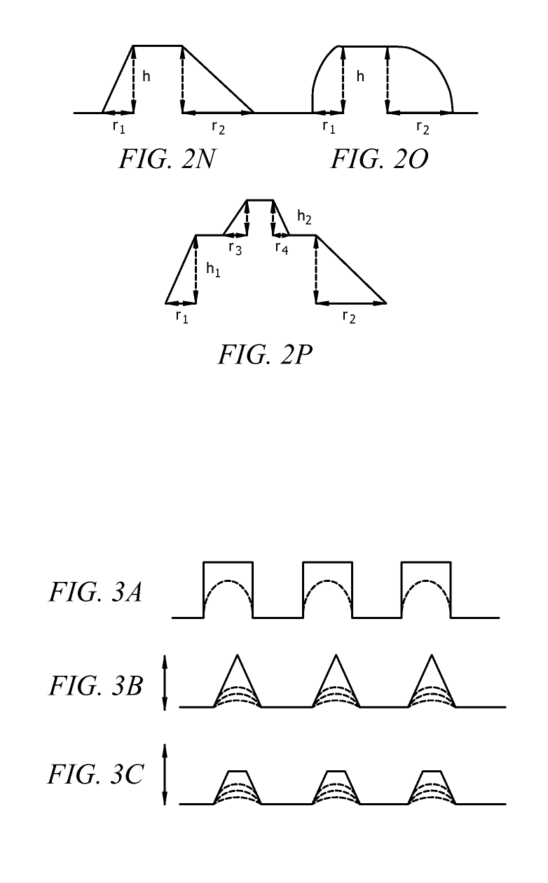

The tilted surface portion formed can be either a planar surface having a tilt or a non-planar (curved) surface. For a planar surface, the tilt angle with respect to the substrate surface is constant (e.g. see FIG. 2C), while for a curved surface (e.g. see FIG. 2E), the tilt angle is a variable and may vary from zero degrees to 90 degrees as defined by the angle of its projection to the substrate, which would be a flat substrate surface in the case of a hemisphere. In the case of a curved surface, the radius of curvature of the curved surface feature is generally 10 nm to 5,000 microns. In another embodiment, the structure formed can be a combination of a fixed tilt angle portion from 3 degrees to 85 degrees, and a variable tilt angle portion from zero to 90 degrees.

The material removal rate during conventional CMP depends on process parameters including the applied pressure, linear velocity, the characteristics of the polishing medium (pad and slurry), and the wafer material. Among these, applied pressure and the properties of the pad are the only parameters which generally significantly affect the contact pressure during CMP. Material removal at any location on the wafer is generally directly proportional to the contact pressure.

The Inventors have recognized that while contact pressure is uniform for a featureless flat wafer, for a wafer with high and low elevation features it can vary significantly along the area of the wafer. The Inventors have recognized that bringing together the polishing pad with appropriate stiffness characteristics and a wafer under an applied pressure for appropriate contact times leads to deformation of the pad along the features on the wafer. This variation in contact pressure and hence removal rate is used by a first embodiment of the invention to enable CMF to form articles having various feature shapes. As described below, the polishing contact times are outside the boundaries of processing times in which a polished surface can be considered to be a planar surface.

CMF methods forming articles having tilted surface features can comprise providing a substrate having a patterned surface comprising at least one protruding or recessed feature. The protruding or recessed feature comprises a first composition, having a pre-CMF high portion and a pre-CMF low portion, wherein a vertical distance (height) between the pre-CMF high portion and pre-CMF low portion is >10 nm, and the pre-CMF high portion (e.g. top of the feature) includes a center portion and an edge portion.

The center portion and edge portion of the pre-CMF high portion of the protruding/recessed feature(s) are contacted with a polishing pad having a slurry composition therebetween. The contact pressure at the center portion is lower than the edge portion. The slurry composition is moved relative to the protruding/recessed feature, wherein the edge portion polishes at a faster polishing rate as compared to a polishing rate of the center portion to form at least one tilted surface feature. The tilted surface feature comprises at least one surface portion having a surface tilt angle from 3 to 85 degrees and a surface roughness<5 nm rms. The surface roughness can be <2 nm rms, such as <1 nm rms. In some embodiments the surface roughness is <0.5 nm rms, such as <0.3 nm rms when the substrate comprises a single crystal substrate. One exemplary tilted surface feature shape is a microlens (see FIG. 2L).

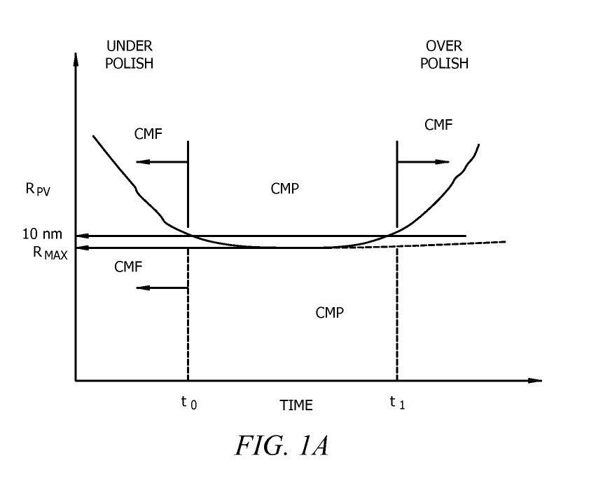

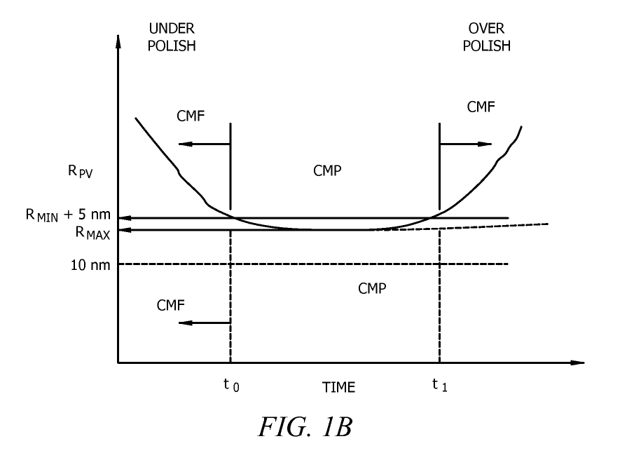

The time to create tilted surface feature(s) according to an embodiment of the invention can be estimated from the time to reach planarization. FIG. 1A shows a plot of the high and low (or peak to valley) height (Rₚᵥ) of the feature(s) as a function of processing time that defines the two (2) CMF zones relative to CMP along with a cross sectional depiction of the resulting structure process as time proceeds (dashed lines), according to an embodiment of the invention. The features polished using CMF can be single layer structures, or multiple layer structures (e.g., copper over a damascened dielectric layer).

FIG. 1A demonstrates that the polishing times (t) for CMF can be t<t₀, or t>t₁. t<to is before planarization and is termed “under-polish” for a CMP process and t>t1 is after planarization, which represents “over-polish” for a CMP process. As described above, a planarized surface is defined as h/r<0.01. Rₚᵥ can be seen to be greater than 10 nm in both CMF time regimes, and <10 nm for conventional CMP processing. In the under-polish regime, Rₚᵥ decreases from its initial value provided that is based on the feature height formed as the CMF process proceeds. In the over-polish regime, dishing occurs to render the substantially planarized structure obtained from the CMP time regime to have an increasing Rₘₐₓ as the polishing time proceeds due to increased dishing which occurs when the two or more surface compositions are being polished simultaneously (feature material different from substrate material). However, if the surface comprises a single surface compositions (feature material the same as the substrate material), the surface generally remains planar during overpolish and is thus not generally useful for forming tilted surface features.

In another variant of this embodiment, the height difference between the high and low portions of the features after polishing may not reach the planarization zone value (defined as the height difference between high and low portion of the features being less than 10 nm). FIG. 1B shows a plot of the high-low portion of the features as a function of polishing time that defines the CMF zones relative to CMP in the embodiment where the minimum Rₚᵥ values do not reach below 10 nm. In such a case the CMP zone is defined by polishing times when the surface has a height with Rₘᵢₙ+2 nm, where Rₘᵢₙ is defined herein as the minimum height difference between the high and low portions reached during the polishing process. The time to enter planarization zone (denoted by CMP) is again defined as tₒ. If the surface does not include two dissimilar polishing surface compositions, (single composition surface for substrate and features), the article can be expected to remain in the CMP zone for the duration of the polishing process. If the polishing surface is composed of dissimilar materials of two or more different composition having different polishing rates, new topographies are expected to be created because of this effect. In this case the height difference between the high and low portions of the features generally again exceed 10 nm and the material is expected to become deplanarized.

The time when the material exits the CMP zone is shown in FIG. 1B as t₁. The fabrication of the articles by this embodiment in this regime occurs for t>t₁. Typically, the fabrication of the articles utilize polishing times less than tₒ−1 seconds, or greater t₁+1 second. The polishing times can be less than tₒ−3 seconds or greater t₁+3 seconds. In another embodiment the polishing time is less than tₒ−6 seconds or greater t₁+6 seconds. In other embodiments, the polishing time is between zero and tₒ−1.5 seconds, or between t₁+6 seconds and t₁+250 minutes.

In some applications it is desirable to have a low surface roughness and reduced sub-surface damage. Known methods for creating curved or tilted surfaces, include reactive ion etching (RIE) through an etch mask, chemical etching through an etch mask using appropriate chemicals, or etching with a laser or partial cutting using a mechanical saw such as wire saw. Other known methods include ion beam etching through a mask, focused ion beam patterning. These techniques are suited to provide vertical-like surface features, with limited ability to develop tilted surfaces. These techniques all typically create higher surface roughness>3 nm rms for single crystal, polycrystalline and amorphous materials. RIE, mechanical sawing or laser cutting also create significant subsurface damage that can extend at least 10 nm or more below the surface. Sub-surface damage is defined as displacement of atoms from their original position as a result of external processing to pattern the substrate. The amount of surface damage and surface roughness typically increases as the process time is extended. In contrast, embodiments of the embodiments do not create any measurable sub-surface damage (maximum within 5 nm), and typically remove the damage caused by other processes. The sub-surface damage can be measured by techniques such as grazing angle X-ray diffraction and cathodoluminescence (CL) techniques.

In one embodiment, RIE together with a lithographically printed pattern is used to form the patterned pre-CMF surface. By etching near vertical walled trenches for depths greater than several microns, RIE is known to be capable of forming vertical-walled (nearly 90 degrees relative to the substrate surface) protruding features, with the high portions corresponding to the non-etched region and the low portions being the etched trench or via region. Such vertical or near vertical walls can be created by several techniques besides RIE as described above. The height of the features can generally vary from 50 nm to 1,000 microns, while the lateral dimension of the features can generally vary from 50 nm to 2,000 microns.

The patterned surfaces can comprise metal, ceramic, insulator, semiconductor, polymer or comprise a biological material. Specific examples include, metallic materials (e.g. Mo) and metal alloys such as steel, transparent conducting oxides such as Indium tin oxide (ITO), other oxides, sulfides, tellurides, other insulators or semiconductors such as III-V materials (such as GaAs, GaN, AlN), Group IV semiconductors (such as Si, SiC, Ge, SiGe), II-VI materials (such as ZnS, ZnSe, ZnTe), Ta, GaN, SiNₓ, SiOₓ, SiOₓN_{y}, Sapphire, alumina, TiO₂, ZnS, Ta₂O₅, glass, steel, Mo, ZnO, tin oxide, CdTe, CdS, silicon, Copper Indium Gallium Selenide (CIGS), phosphors composed of oxides, spinels, gallates and sulfides, polymers such a PMMA, polystyrene, polycapralactone, polylactic acid/polygalactic acid. The materials system can be composites or mixtures and can also have recessed or damascene structures similar to formation of copper interconnects in silicon based devices. The materials system can have layers of different composition below the surface layers The materials described above represent only a small number of solids and the scope of embodiments of the invention are not limited to the materials described above.

The pressure used in the CMF process can generally vary from 0.1 psi to 50 psi. More typically, the pressure during CMF can vary from 1 psi to 20 psi, such as 2 psi to 15 psi. The linear velocity during CMF can generally vary from 0.001 m/sec to 50 m/sec, such as 0.01 ms/sec to 5 m/sec, typically 0.1 m/sec to 2 m/sec. The pads used can vary from soft pads to hard pads. Examples of pads includes Politex and Suba IV, IC 1000 pads made by Rohm and Haas Company, Delaware D_{—}100 pads made by Cabot Microelectronics, Illinois. Other example includes pad made of natural and manmade materials such as wool, cloth. Typically higher curvatures can be achieved by a softer pad, where as smaller curvatures can be obtained by a harder pad. The temperature for CMF can generally vary from 0° C. to 150° C., such as around room temperature (25° C.). At higher temperatures compared to room temperature the polish rates may be higher which may be desirable for the fabrication process. Also at higher temperatures the mechanical polishing pad becomes softer which may lead to higher curvature structures.

The polish rate used for CMF according to embodiments of the invention can vary from 0.1 nm per minute to 20 microns/min, such as 1 nm/min to 1 micron/min. The polish rate can be controlled by the chemistry of the slurry and the polishing parameters (velocity, pad, pressure) of the polishing tool.

The slurry chemistry for the CMF process may comprise several chemicals and/or abrasives. The chemicals can include oxidizers, surfactants, salts, biocides, pH buffering agents, and chelating agents. The particles can include abrasives such as silica, ceria, titania, diamond, alumina, silicon nitride, diamond, zirconia, yttria, and non soluble oxides and compounds of transition metals. Coated and uncoated particle can generally be used. The concentration of the particles can generally vary from 0.001 to 50 weight percent. The size of the particles can generally vary from 0.5 nm to 1 mm. The particles mentioned above represent only exemplary particles and the scope of embodiments of the invention are not limited to the particles disclosed herein. The surfactants used can generally be cationic, anionic or non-ionic. The particles and the chemicals dispersed in the slurry can be organics or aqueous liquid or mixtures thereof.

The polishing composition generally comprises oxidizing agents, which can be suitable for one or more materials of the substrate to be polished. The oxidizing agent can be selected from cerium ammonium nitrate, potassium persulfate, potassium peroxy monusulfate, halogens, H₂O₂, oxides, iodates, chlorates, bromates, periodates, perchlorates, persulfates, phosphates and their mixtures thereof, such as sulfates, phosphates, persulfates, periodates, persulfates, periodates, perchlorates, chromates, manganates, cynanides, carbonates, acetates, nitrates, nitrites, citrates of sodium, potassium, calcium, magnesium. The oxidizing agent present in the polishing composition can generally be ≧0.001 wt %.

The pH of the polishing composition can generally vary from 0.5 to 13.5. The actual pH of the polishing composition will generally depend, in part, on the type of the mixture and type of the feature materials polished. The pH of the composition can be achieved by a pH adjuster, buffer or combination thereof. The pH can generally be adjusted using any organic or inorganic acid and organic or inorganic base.

The polishing composition can comprise a chelating or complexing agent such as aldehydes, ketones, carboxylic acid, ester, amide, enone, acyl halide, acid anhydride, urea, carbamates, the derivatives of acyl chlorides, chloroformates, phosgene, carbonate esters, thioesters, lactones, lactams, hydroxamates, isocyanates, alcohols, glycolates, lactates. The complexing agent is any suitable chemical additive that can remove the metal contaminants and enhance polishing rates. The chelating agents can be of Acrylic polymers Ascorbic acid, BAYPURE® CX 100 (tetrasodium iminodisuccinate), Citric acid, Dicarboxymethylglutamic acid, Ethylenediaminedisuccinic acid (EDDS), Ethylenediaminetetraacetic acid (EDTA), Hepta sodium salt of diethylene triamine penta (methylene phosphonic acid) (DTPMP.Na₇), Malic acid, Nitrilotriacetic acid (NTA), Nonpolar amino acids, such as methionine, Oxalic acid, Phosphoric acid, Polar amino acids, including: arginine, asparagine, aspartic acid, glutamic acid, glutamine, lysine, and ornithine, Siderophores such as Desferrioxamine B, Succinic acid, benzotriazole, (BTA), tartrates, succinates, citrates, phthalates, carboxylates, amines, alcohols, malates, edetates, thereof.

The slurry composition can comprise salts that can be formed from the organic or inorganic acids & bases. Salts can comprise cations such as ammonium NH₄⁺, calcium Ca²⁺, iron Fe²⁺ and Fe³⁺, magnesium Mg²⁺, potassium K⁺, Pyridinium C₅H₅NH⁺, Quaternary ammonium NR₄⁺, sodium Na⁺, copper and anions such as acetate CH₃COO⁻, carbonate CO₃²⁻, chloride Cl⁻, chlorate, perchlorate, bromide, iodide, fluoride, periodates, citrate HOC(COO⁻)(CH₂COO⁻)₂, cyanide C≡N⁻, Hydroxide OH⁻, Nitrate NO₃⁻, Nitrite NO₂⁻, Oxide O²⁻ (water), Phosphate PO₄³⁻, Sulfate SO₄^{2-,} and pthalates.

In another embodiment of the particle or insoluble material content of the slurry composition is less than 0.01 weight percent. Besides the oxidizers, surfactants, salts, biocides, pH buffering agents, chelating agents described above, the slurry composition can comprise other chemical agents used in abrasive based slurries as known in the art. The CMF surface can be further treated to clear the surface from particles, chemicals etc. The chemicals can also be used to chemically further etch the surfaces.

The non-planar or tilted surface feature generally has an h/r ratio greater than 0.05, such as greater than 0.1, or greater than 0.20. The minimum lateral size r of the non-planar or tilted surface features is greater than 50 nm or greater than 500 nm, such as greater than 5 microns. Surfaces of both positive and negative curvature and mixed curvature can also be fabricated. The shape of the structures formed by processes according to embodiments of the invention can be of many generic shapes including microlens, hemispherical, truncated or full pyramids and cones. The feature-to-feature distance between the non-planar or tilted surface features can generally vary from 100 nm to 1,500 microns (1.5 mm).

The non-planar or tilted surface feature(s) formed can be defined by their h/r ratios as shown in FIGS. 2A-P. FIGS. 2A-P show examples of tilted surface features that can be fabricated by CMF methods according to embodiments of the invention including symmetric surfaces (A-E), asymmetric surfaces (F-J), positive curvature surfaces (K), negative curvature surfaces (L), and mixed curvature surfaces (M), and mixed structures (N-P), respectively. In each case, at least one of the surfaces have a height (h)>10 nm, a h/r ratio where r is the lateral dimension varying from 0.05 to 1.0, or a tilt angle of curvature between 3 and 85 degrees. The shapes shown in the FIGS. 2A-P represent a small number of possible shapes and the scope of embodiments of the invention are not limited to the shapes shown.

FIG. 2K is identified as an article 210 having tilted surface features shown as a plurality of recessed surface features 215. The article comprises a substrate 205 and a patterned surface comprising a plurality of recessed surface features 215 having high elevation portions 217 and low elevation portion 218 defining a vertical distance shown as h₂, and having a lateral dimension (shown as r₂), wherein an h₂/r₂ ratio is ≧0.01 and at least one of (i) h is ≧100 nm and (ii) a tilt angle of curvature that is between 3 and 85 degrees. The recessed surface features 215 have a surface roughness≦10 nm rms.

FIG. 2L is identified as an article 230 having tilted surface features shown as protruding surface features comprising microlenses 235. Article 230 comprises substrate 205 and a patterned surface comprising a plurality of microlenses 235 having high elevation portions 238 and low elevation portion 237 defining a vertical distance (h₂), and having a lateral dimension (shown as r₂), wherein an h₂/r₂ ratio is ≧0.01 and at least one of (i) h₂ is ≧100 nm and (ii) a tilt angle of curvature that is between 3 and 85 degrees. The microlenses 235 has a surface roughness≦10 nm rms.

FIGS. 3A-C shows some exemplary feature shapes obtainable using the under-polish regime of CMF, according to an embodiment of the invention. Under-polish corresponds to t<to as shown in FIGS. 1A and 1B. The solid lines show the structure as provided, while the dashed lines show the resulting structure as the time for CMF proceeds (dashed lines).

In another embodiment of the invention, multiple surfaces with different tilt angles can be formed by varying the distance between the patterned structures. For example if the distance between the features is 10 microns in one direction and 20 microns in the other direction, different h/r ratio features can be formed. Features obtained by such methods are referred to herein as asymmetric structures as the h/r ratio and Rₚᵥ varies with respect to different directions on the surface. As described above, examples of asymmetric feature shapes are shown in FIGS. 2F-J.

In one embodiment of the invention, pressure variation during polishing can comprise forming a polishing stop layer comprising a second composition on a portion of the high elevation portion of the protruding feature before the polishing, wherein the second composition has a removal rate during CMF that is ≦0.8 of a CMF removal rate for the first composition. The ratio of the removal (polishing) rate of the first composition and the second composition (stop layer) is defined as the selectivity for the polishing process. The selectivity can vary from 1.25 to greater than 3,000, such as from 2 to 1,000 or from 10 to 500. The polishing rate for the stop layer can generally vary from 0.001 nm/min to 1,000 nm/min. The polishing rate of the substrate composition can generally vary from, 0.001 nm to 20 microns/min. The selectivity of the polishing process can be achieved by controlling the chemical and the mechanical composition of the polishing slurry. To obtain high selectivity the chemical composition and the particle composition can be adjusted so that the removal rate of the stop layer is much lower than that of the substrate layer.

FIG. 4 shows an initial feature profile (solid lines) and a feature profile after CMF (dashed lines) in an embodiment where a polishing stop layer 410 is positioned proximate to the center portion of the high elevation top portion of the features 405, according to an embodiment of the invention. Such a polishing stop layer 410 can be formed on the features using well known deposition and lithography techniques used in conventional IC fabrication. The removal rate of the polishing stop layer 410 is typically less than the removal rate for the material comprising the features 405. Typically, the polishing removal rate of the stop layer 410 is ≦0.5 of a polishing removal rate for the material comprising feature 405. In this case the use of the polishing stop layer 410 results in the creation of tilted surfaces that are not in a shape of a microlens. Some of the feature shapes that can be obtained by the use of a stop layer 410 are, for example, a truncated microlens, conical structures, and truncated cones.

As the polishing selectivity is increased to a value higher than 1.0 (for example, in the range from 2 to 5,000) and the stop layer 410 is patterned to have dimensions smaller than the protruding features 405, the CMF method can be used to increase the h/r ratio of the resulting structures. The h/r ratio of the structure can be increased from 0.01 up to 1.0 by changing and controlling the dimensions of the stop layer 410, the thickness of the stop layer and the selectivity of the stop layer relative to the material in feature 405. This embodiment can also be used to increase the tilt angle of the structure. The tilt angle can be increase from 5 degrees to 85 degrees depending on the dimensions, thickness and the polishing selectivity of the stop layer relative to the material of feature 405.

Furthermore, this embodiment can change the shape of the feature from that of a microlens to a truncated cone-like structure. This typically happens when the dimensions of the stop layer varies from 95% to 0.001% of the area of the top of the protruding features 405. To achieve an increase in tilt angle and a higher h/r ratio, an increase in selectivity is generally desirable. If during the CMF process the edges of the polishing stop layer 410 are polished, both positive and negative curvature structures can be formed simultaneously (see, e.g. FIG. 2K which shows a mixed curvature surface).

Another related method to achieve selective polishing according to another embodiment of the invention is to deposit particle based non-continuous coatings on the surface of the substrate. The particles act as selective mask layers for the CMF process. In such a case, no lithographic pattern is generally needed. The size of the particles can generally vary from 1 nm to 100 microns while the surface coverage of the particles can vary from 0.01% to 60%. The particles can be adhered to the surface by heating so that reaction bonding can take place. The particles can comprise metals, ceramics, polymers or composite materials and their alloys, or mixtures thereof.

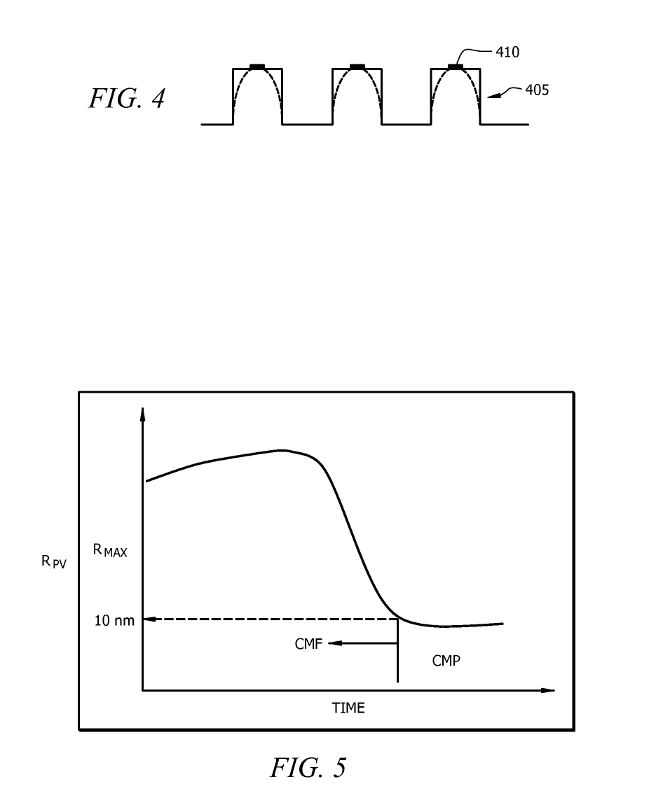

FIG. 5 shows a plot of the peak to valley height (Rₚᵥ) as a function of polishing time that defines the CMF zones relative to CMP for the polishing stop layer comprising embodiment, according to an embodiment of the invention. The steep decrease in Rₚᵥ during CMP is when the polishing stop layer has been slowly polished away which leads to the polishing of the entire feature, resulting in a sharp decrease in the Rₘₐₓ value.

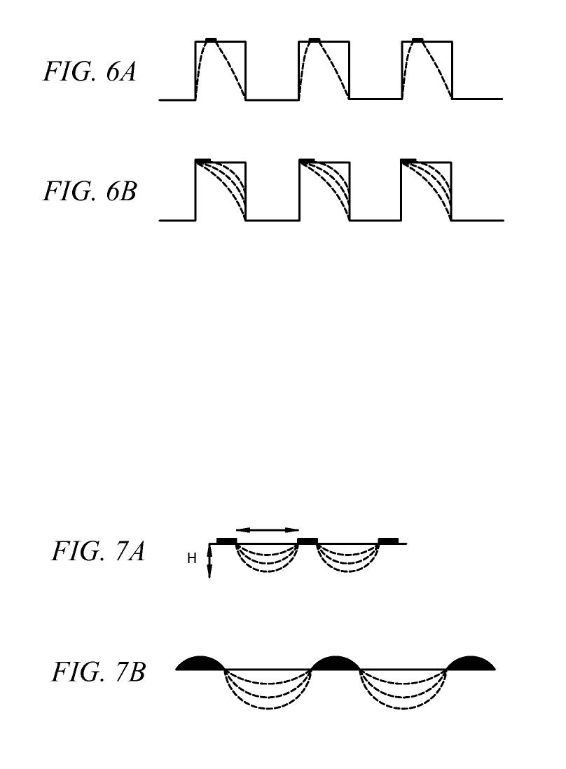

In another embodiment of the invention the polishing stop layer is positioned proximate to an edge portion on the top of the features. FIGS. 6A and B show an initial feature profile (solid lines) and a feature profile after CMF for various times (dashed lines) in the embodiment where polishing stop layer is positioned proximate to an edge portion of the top of the features, according to an embodiment of the invention. As shown, this embodiment creates asymmetric features.

Another embodiment of the invention comprises a CMF method for forming articles having curved and tilted features that is based on polishing selectivity. If the surface includes two (or more) different materials that have different polishing rates on its surface, such as a first material on one portion of the surface and a second material on another portion of the surface, the polishing slurry can be designed (e.g., using suitable chemistry) by having a high relative polishing selectivity to one of the materials (e.g., the first material) relative to the other material (e.g., the second material). Thus, the first material will polish faster than the second material. In one embodiment, an etch mask can be formed to provide the lower polishing rate to achieve non-planar polishing.

FIGS. 7A and B show a depiction of respective materials that have surfaces including different widths and different polishing rates, and feature profiles before (solid lines) and after CMF (dashed lines) obtained by polishing such surfaces, according to an embodiment of the invention.

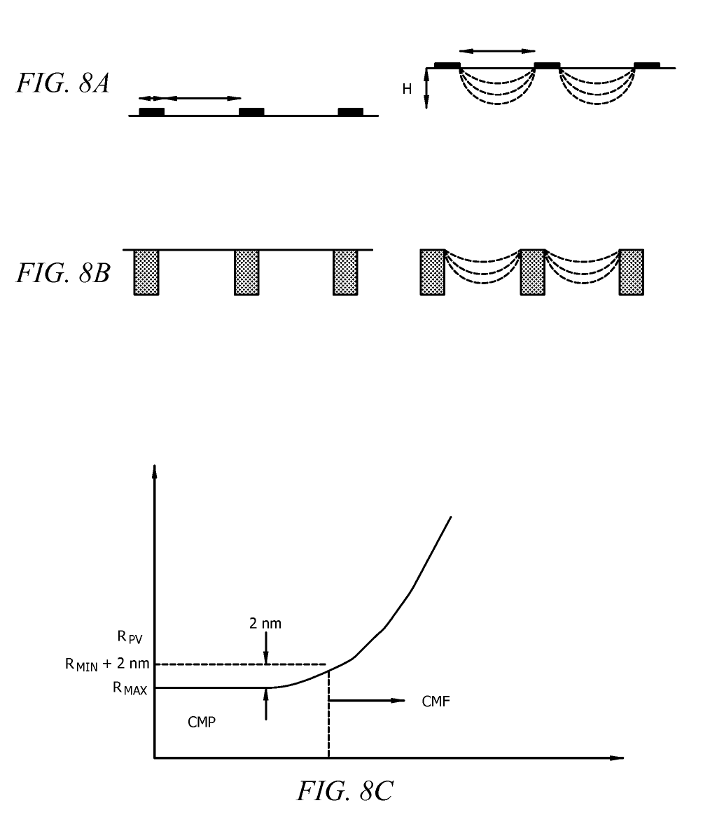

FIGS. 8A and B shows a feature profile before (solid lines) and after CMF (dashed lines) in the compositionally patterned embodiment where the starting structure is a substantially planar surface (Rmax<1 nm) comprising two materials with different removal rates during polishing (selectivity), according to an embodiment of the invention. FIGS. 8A and 8B demonstrate the disclosed compositionally patterned embodiment. FIG. 8C shows a plot of R_{PV} vs. time showing times for the CMF regime, according to an embodiment of the invention. Rₚᵥ is seen to increase as a function of time to reach an Rₘₐₓ value of >Rₘᵢₙ+2 nm which defines the onset of CMF. Rₘᵢₙ corresponds to the minimum Rₚᵥ values which in this case is small as the surfaces are substantially flat. When the two materials are polished together, the material with higher removal rate is polished at a higher rate. This leads to formation of valleys in the material which polishes faster. The increase in the Rₘₐₓ value with polishing indicates the formation of deeper dishes. Once the deep dishes are formed then placing a smaller stop layer on the surface, the tilt of the dish wall can be sloped further as desired.

The pressure variations during polishing and polishing selectivity embodiments may also be combined. In this embodiment, a patterned (non-planar) surface comprising at least one protruding feature is provided and selective polishing of the protruding feature is employed by having the protruding/recessed feature include a polishing stop layer or pattern on the surface of the feature.

Another embodiment of the invention is for creating CMF structures on non-flat or non-planar substrates. Examples of non-planar structures include spheres, cylinders, and non-flat three dimensional shapes. The CMF structures can be formed by using pads which contort to take the rough shape of the substrates or the use of three dimensional shaped pads such as hollow cylinder shaped. Other examples of pads used in these applications could be a pad size much smaller than the object to be polished and equipment that can change the position of the pad with respect to the substrate in a dynamic manner, or applying the same pressure onto the substrate irrespective of substrate position. In the case of non-planar substrate, the methodology is essentially same as outlined above.

Embodiments of the invention can be used for a variety of different processes to form a variety of different devices. For example, to make optical-based devices such as solar cells, electroluminescent (EL) devices, light emitting diodes (LEDs), organic LEDs, solid state lasers, and certain medical devices. Other examples include growth of films on patterned surfaces.

### EXAMPLES

Embodiments of the invention are further illustrated by the following specific Examples, which should not be construed as limiting the scope or content of embodiments of the invention in any way.

### Example 1

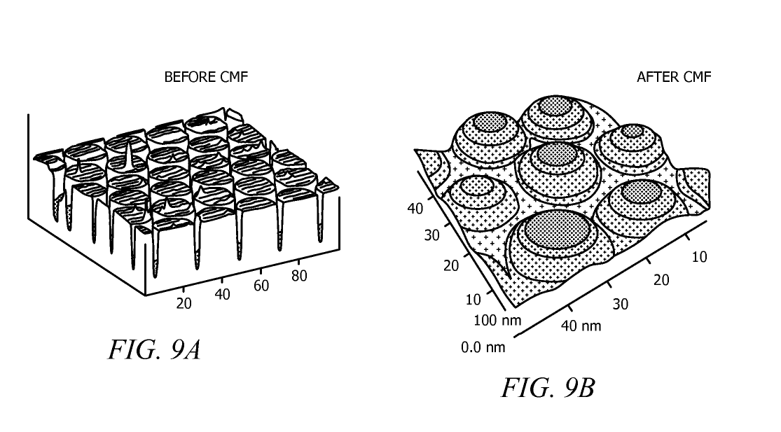

This Example depicts the formation of microlens-like structures using the CMF method on silica or glass-like surfaces. Flat silica substrates were patterned by RIE to obtain approximately 700 nm tall substantially planar top pillars as shown in the depictions based on AFM images shown in FIG. 9A. The CMP method was then used in the underpolish CMF regime to create microlens structures shown. Using a 5 weight % 80 nm silica slurry, the pillars were polished at pH 4.0 and 2.5 psi using a Struers Rotopol machine. A politex pad was used for this fabrication process. The planarization time for such a structure was determined to be 250 seconds (corresponding to t₀ shown in FIGS. 1A and 1B). The depiction based on an AFM image shown in FIG. 9B evidences the formation of microlens structures. The surface roughness of the structures measured was found to be less than 2A. The h/r ratio of the structures varied from 0.07 at the start of the polishing process and decreased to 0.04 after approximately 15 seconds and 0.02 after 120 seconds. The tilt angle of the curved surface changed from 90 degrees (initially vertical) to 10 degrees to approx 2.5 degrees after 120 seconds.

### Example 2

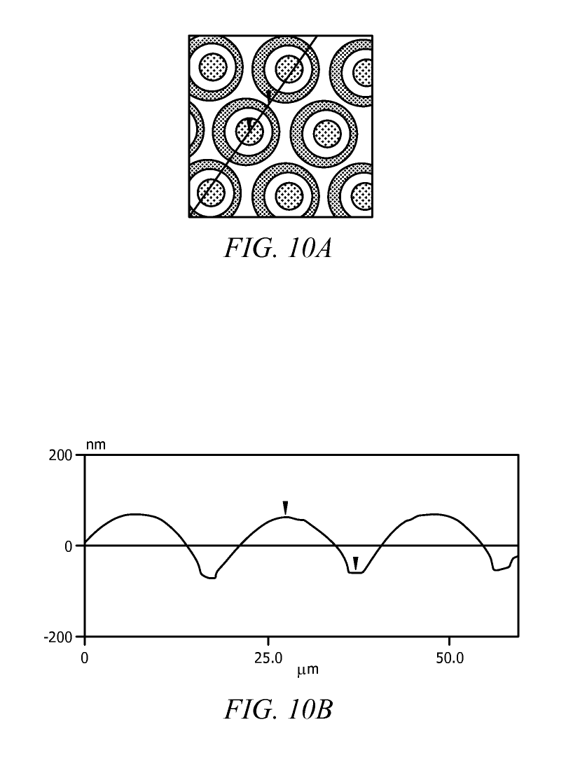

This Example depicts positive and negative curvature structures using the CMF method on silica or glass-like surfaces. The flat silica substrates were patterned by RIE to obtain approximately 700 nm tall substantially planar top pillars as described above. The CMP method was used in the underpolish CMF regime to create microlens structures. Using 5% 80 nm silica slurry, the RIE structures were polished at pH 4.0 and 2.5 psi using a Struers Rotopol machine. A Politex pad was used for this fabrication process. The planarization time for such a structure was determined to be 250 seconds (corresponding to t₀ shown in FIGS. 1A and 1B). A depiction based on an AFM image is shown in FIG. 10A along with FIG. 10B which is a plot of the height of the surface along the reference line shown in FIG. 10A which evidences the formation of both positive and negative curvature surfaces. The positive curvature surface is formed on protruding surfaces while negative curvature is formed recessed surfaces. The height of the structures is seen in FIG. 10B to be approximately 100 nm.

### Example 3

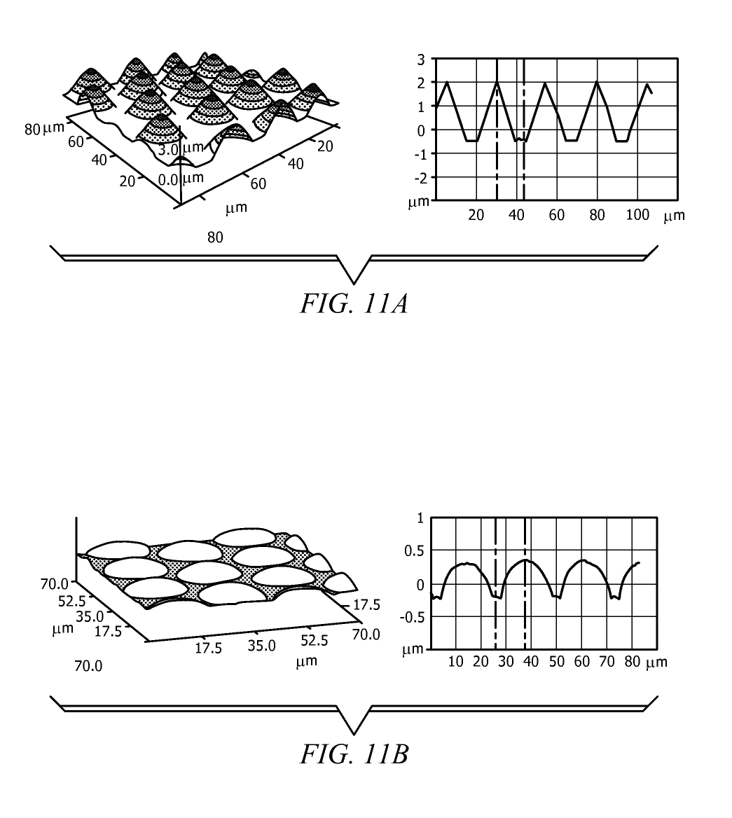

This Example depicts the formation of cone-like structures using the CMF method on silica or glass-like surfaces using chemical etching methods. Flat silica substrates were patterned by chemical etching using a selective etch mask to obtain approximately 2,500 nm tall pillars shown in depiction based on an AFM image shown FIG. 11A. A plot of the height of the surface as a function of lateral distance is also provided. The etching conditions used were 5 vol. percent HF for 4 minutes. The CMP method was then used in the underpolish CMF regime to create a microlens structures. The CMF comprised using 5% 80 nm silica slurry with HNO₃ to adjust the pH to 4, and the structures were polished at pH 4.0 and 2.5 psi using a Struers Rotopol machine. A Politex pad was used for this fabrication process. The planarization time for such a structure was determined to be approximately 700 seconds (corresponding to t₀). The depiction based on an AFM image of the CMF structures are shown in FIG. 11B after polishing for 120 seconds at 50 rpm. A plot of the height of the surface as a function of lateral distance is also provided. The mean roughness of the resulting structures measured were less than 2A rms. The height (h) of the microlens structures is seen to be approximately 500 nm.

### Example 4

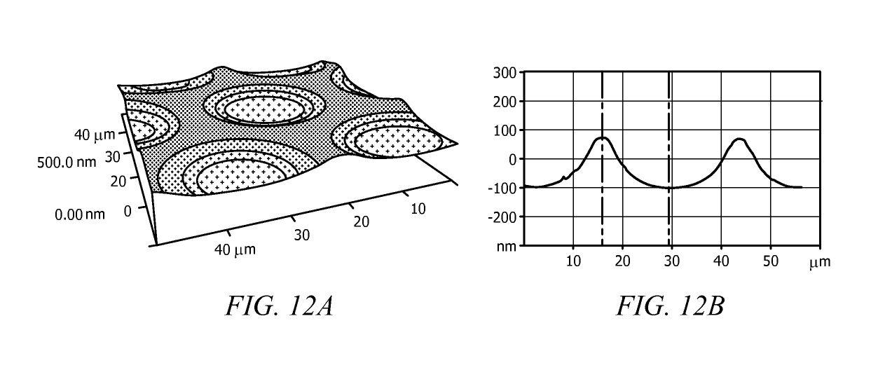

This Example depicts the formation of negative curvature surfaces on glass/silica using the selectivity method described above. The sample was a flat silica substrate with no patterning. A TiB₂ mask was deposited and patterned on the silica surface. Using 5% 80 nm silica slurry, the patterned structures were polished at pH 4.0 and 2.5 psi using a Struers Rotopol machine. A politex pad was used for this fabrication process. The time which the materials exited the planarization regime (t₁) was estimated be to less than 10 seconds. The polishing selectivity between glass and TiB₂ layer was determined to be 2.6. The selective polishing process led to formation of the CMF structure. A depiction based on an AFM image is shown in FIG. 12A which evidences the formation of negative curvature microlens structures after 120 seconds of polishing along with FIG. 12B which is a plot of the height of the surface as a function of lateral distance is shown in FIG. 12A. Including the stop layer surface, this method results in the formation of a composite structure having a flat surface and a negative microlens structure. The mean roughness of the structures measured were less than 2A rms. The height (h) of the structures as seen in FIG. 12B is approximately 180-200 nm. This example also shows an example of increasing the h/r ratio of a insulating material from zero to a positive value using this polishing process. Furthermore, starting with this formed structure, if the dimensions of the stop layer are reduced compared to the flat protruding surface, the negative microlens structure shape will be modified. The main changes that generally occur are (i) the shape of the structures will become more conical (triangular projection) projection and the tilt angle will decrease. If the initial tilt angle is high (e.g. close to 90 degrees) it will reduce to anywhere between 90 and 5 degrees depending on the dimension of the pattern, selectivity of polishing and the thickness of the stop layer. So this method can be used to achieve a desired tilt angle of the structure.

### Example 5

### CMF Structures in Silicon Carbide

A patterned silicon carbide substrate using the RIE method was polished to create the CMF enabled structures. Both a patterned surface and polishing selectivity methods can be used. A CMP slurry composition that polishes SiC at rates greater than about 500 nm/hr may be used to create the CMF structure. A typical slurry containing silica (or coated silica) particles with permanganate solutions (e.g. KMnO₄) can be used to achieve such rates. Alternative mask materials such as diamond, alumina or silica layers can be deposited on the surface of the patterned or unpatterned structures. The selectivity of the polishing process can be at least 1.25. Microlenses, with h values between 0.1 microns to 100 microns can be produced by the method. Including the stop layer surface, this method results in the formation of a composite structure have a flat surface and a negative microlens structure.

### Example 6

### CMF Structures Sapphire Substrates

A patterned sapphire substrate formed by using RIE/or a chemical etching method can be polished to create the CMF structures. Both patterned surface and polishing selectivity methods can be used. A CMP slurry composition than polishes sapphires at a rate greater than 1000 nm/hr may be used to create the CMF structure. A typical slurry for this purpose may comprise silica (or coated silica) particles with salts (NaCl) with HNO₃ sufficient to reach a pH of about 4. The polishing can be either done at room temperature up to a temperature of about 100° C. The removal rate at 83° C. was found to be approximately 2.5 times higher than at room temperature. Alternative mask materials such as silica, tantalum, or carbon layers can be deposited on the surface of the patterned or unpatterned sapphire structures. The selectivity of the polishing process can be at least of 1.25. Microlenses, with h values greater than 1 micron structures can be produced by this method. Including the stop layer surface, this method can result in the formation of a composite structure having a flat surface and a negative microlens structure.

### Example 7

### CMF Structures on Metallic Substrates

A patterned damascene copper substrate with an underlying layer of silica and tantalum can be used to demonstrate the formation of the CMF structures on metallic substrates.

A CMP slurry composition that polishes copper at rates greater than 1,000 A/min may be used to create the CMF structure. A typical slurry contains 10 mM iodine, BTA and citric acid. The selectivity of the copper polishing process with respect to tantalum is greater than 1,000. This process yields both positive and negative curvature surfaces.

While various disclosed embodiments have been described above, it should be understood that they have been presented by way of example only, and not limitation. Numerous changes to the disclosed embodiments can be made in accordance with the disclosure herein without departing from the spirit or scope of the invention. Thus, the breadth and scope of the disclosed embodiments should not be limited by any of the above described embodiments. Rather, the scope of the invention should be defined in accordance with the following claims and their equivalents.

Although this disclosure has been illustrated and described with respect to one or more implementations, equivalent alterations and modifications will occur to others skilled in the art upon the reading and understanding of this specification and the annexed drawings. In addition, while a particular disclosed feature may have been disclosed with respect to only one of several implementations, such feature may be combined with one or more other features of the other implementations as may be desired and advantageous for any given or particular application.

The terminology used herein is for the purpose of describing particular embodiments only, and is not intended to be limiting. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of this Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

We claim:

1. A method of chemical-mechanical fabrication (CMF) for forming articles having tilted surface features, comprising:
contacting a substrate having a patterned surface with a polishing pad having a slurry composition therebetween, and
moving said slurry composition relative to said patterned surface to form at least one tilted surface feature,
wherein said tilted surface feature comprises at least one surface portion having (i) a surface tilt angle from 3 to 85 degrees, and (ii) a surface roughness<5 nm rms, and
wherein said tilted surface feature has a post-CMF high elevation portion and a post-CMF low elevation portion that defines a maximum height (h), and wherein said tilted surface feature defines a minimum lateral dimension (r), further wherein h/r is ≧0.05.

2. The method in claim 1, wherein said patterned surface comprises at least one protruding or recessed feature, said protruding or recessed feature comprising a first composition and having a pre-CMF high portion and a pre-CMF low portion, wherein a vertical distance between said pre-CMF high portion and said pre-CMF low portion is ≧10 nm, said pre-CMF high portion including a center portion and an edge portion.

3. The method in claim 1, wherein said patterned surface comprises two or more layers of different compositions.

4. The method of claim 1, wherein said h/r ratio is ≧0.1.

5. The method of claim 2, wherein said protruding or recessed feature comprises a protruding rectangular feature.

6. The method of claim 3, wherein said two or more layers of different compositions provide a polishing selectivity of >1.5.

7. The method in claim 1, wherein said two or more layers of different compositions provide a polishing selectivity of >20.0.

8. The method of claim 1, wherein said patterned surface comprises a plurality of protruding features, wherein a top surface of said plurality of protruding features have a polishing stop layer on a portion of said top surface.

9. The method of claim 8, wherein said polishing stop layer is positioned proximate to said center portion of said top surface.

10. The method of claim 8, wherein said polishing stop layer is positioned proximate to an edge portion of said top surface.

11. An article, comprising:
a substrate having a patterned surface;
wherein said patterned surface comprises:
a plurality of protruding or recessed tilted surface features, said plurality of surface features having (i) a surface tilt angle from 3 to 85 degrees, and (ii) a surface roughness<5 nm rms, and
wherein said tilted surface features includes a high elevation portion and a low elevation portion that defines a height (h)>100 nm, and wherein said tilted surface feature defines a minimum lateral dimension (r), and wherein h/r is ≧0.05.

12. The article of claim 11, wherein said h/r ratio is ≧0.1.

13. The article of claim 11, wherein said surface roughness is <0.5 nm rms.

14. The article of claim 11, wherein said substrate comprises a single crystal substrate and said surface roughness is <0.3 nm rms.

15. The article of claim 11, wherein said patterned surface and said substrate comprise the same material.

16. The article of claim 11, wherein said tilted surface features are microlens shaped.

17. The article of claim 11, wherein said patterned surface comprises a metal, semiconductor, ceramic or a dielectric.

18. The article of claim 11, wherein said patterned surface comprises a glass, SiC, GaN, a carbide, a nitride, sapphire, an oxide, an optically transparent electrically conducting oxide, or a phosphor.

19. The article of claim 11, wherein said tilted surface features provide a positive curvature.

20. The article of claim 11, wherein said tilted surface features provide a negative curvature.
